(19) United States
(12) Patent Application Publication
(10) Pub. No.: US 2025/0378822 A1
(43) Pub. Date: Dec. 11, 2025

(54) SPEECH RECOGNITION MODEL TRAINING

(71) Applicants: Beijing Zitiao Network Technology Co., Ltd., Beijing (CN); Lemon Inc., Grand Cayman (KY)

(72) Inventors: Minglun HAN, Beijing (CN); Linhao DONG, Beijing (CN); Lu LU, Los Angeles, CA (US)

(21) Appl. No.: 19/234,625

(22) Filed: Jun. 11, 2025

(30) Foreign Application Priority Data
Jun. 11, 2024 (CN) 202410750132.X

(51) Int. Cl. G10L 15/06; G10L 15/22

(52) U.S. Cl. CPC G10L 15/063; G10L 15/22

(57) ABSTRACT

A method, an apparatus, a device, and a storage medium related to training a speech recognition model are provided. An example method provided here includes: obtaining a speech sample set, the speech sample set including a first set of speech samples and a second set of language samples, a time length of the first set of speech samples being less than a first threshold, and a time length of the second set of speech samples being greater than a second threshold; and training the speech recognition model with the speech sample set and corresponding text information, to at least adjust parameters of a speech encoding unit in the speech recognition model, the speech recognition model including the speech encoding unit configured to generate a speech encoded representation of speech content and a decoding unit configured to generate a speech recognition result based on the speech encoded representation.

### CROSS-REFERENCE

This application claims the benefit of Chinese Patent Application No. 202410750132.X, filed on Jun. 11, 2024, entitled “METHOD, APPARATUS, DEVICE AND STORAGE MEDIUM FOR TRAINING SPEECH RECOGNITION MODEL”, the entirety of which is incorporated herein by reference.

### FIELD

Example embodiments of the present disclosure generally relate to the field of computers, and in particular, to speech recognition model training.

### BACKGROUND

In recent years, with rapid development of machine learning technologies, speech recognition models realized based on machine learning technologies are widely used to improve the efficiency of people to process speech content. However, the existing speech recognition model cannot meet the needs of people to process speech content.

### SUMMARY

In a first aspect of the present disclosure, a method for training a speech recognition model is provided. The method includes: obtaining a speech sample set, the speech sample set including a first set of speech samples and a second set of language samples, a time length of the first set of speech samples being less than a first threshold, and a time length of the second set of speech samples being greater than a second threshold; and training the speech recognition model with the speech sample set and corresponding text information, to at least adjust parameters of a speech encoding unit in the speech recognition model, the speech recognition model including the speech encoding unit and a decoding unit, the speech encoding unit being configured to generate a speech encoded representation of speech content, and the decoding unit being configured to generate a speech recognition result based on the speech encoded representation.

In a second aspect of the present disclosure, an apparatus for training a speech recognition model is provided. The apparatus includes: an obtaining module, configured to obtain a speech sample set, the speech sample set including a first set of speech samples and a second set of language samples, a time length of the first set of speech samples being less than a first threshold, and a time length of the second set of speech samples being greater than a second threshold; and a training module, configured to train the speech recognition model with the speech sample set and corresponding text information, to at least adjust parameters of a speech encoding unit in the speech recognition model, the speech recognition model including the speech encoding unit and a decoding unit, the speech encoding unit being configured to generate a speech encoded representation of speech content, and the decoding unit being configured to generate a speech recognition result based on the speech encoded representation.

In a third aspect of the present disclosure, an electronic device is provided. The electronic device includes: at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium stores a computer program thereon, and the computer program is executable by the processor to implement the method of the first aspect.

It should be understood that the content described in this Summary section is not intended to limit the key features or critical features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference signs refer to the same or similar elements, where:

FIG. 1 illustrates a schematic diagram of an example environment in which embodiments according to the present disclosure may be implemented;

FIG. 2 illustrates a flowchart of an example process of training a speech recognition model according to some embodiments of the present disclosure;

FIG. 3 illustrates an example structure of a speech recognition model according to some embodiments of the present disclosure;

FIG. 4 illustrates a schematic structural block diagram of an example apparatus for training a speech recognition model according to some embodiments of the present disclosure; and

FIG. 5 illustrates a block diagram of an electronic device capable of implementing a plurality of embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined with any other embodiment described in the same section/subsection and/or different sections/subsections in any manner.

In the description of the embodiments of the present disclosure, the terms “comprising/including” and its equivalents should be construed as being open-ended inclusive, i.e., “including, but not limited to”. The term “based on” should be construed as “based at least in part on”. The terms “one embodiment” or “the embodiment” should be construed as “at least one embodiment”. The term “some embodiments” should be understood as “at least some embodiments”. Other definitions, either explicit or implicit, may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all comply with the corresponding laws and regulations and related provisions. In the embodiments of the present disclosure, all data is collected, obtained, processed, processed, forwarded, used, etc., all of which are performed on the premise that the user knows and confirms. Accordingly, when implementing the embodiments of the present disclosure, the user should be informed of the types, use ranges, use scenarios, and the like of the data or information that probably involved in an appropriate manner according to relevant laws and regulations and the user's authorization may be acquired. The specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or necessary for performing a fulfillment contract), and shall be processed only within a specified or agreed range. The user rejecting personal information other than necessary information required for the basic function would not affect the basic function of the user.

As used herein, the term “model” may learn an association relationship between respective inputs and respective outputs from training data. Therefore, a corresponding output may be generated for a given input after training is complete. The generation of the model may be based on machine learning techniques. Deep Learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network”. These terms can be used interchangeably herein.

Generally, machine learning may generally include three stages, a training stage, a testing stage, and an application stage (also referred to as an inference stage). At the training stage, a given model may be trained using a large amount of training data, and constantly updating the parameter values, until the model is able to obtain consistent inferences that satisfy the expected objectives from the training data. Through training, the model may be considered to be able to learn an association between an input and an output (also referred to as a mapping from input to output) from the training data. The parameter values of the trained model are determined. In the testing stage, the test input is applied to the trained model to test whether the model can provide the correct output, thereby determining the performance of the model. The testing stage may sometimes be fused in a training stage. In the application or inference stage, the trained model may be used to process the actual model input based on the parameter value obtained by training, to determine a corresponding model output.

As mentioned above, with the rapid development of the machine learning technology, the speech recognition model implemented based on the machine learning technology is widely used to improve the efficiency of people to recognize speech content. However, the existing speech recognition model has a single capability to recognize speech content, and can only process specific speech content, and cannot meet the needs of people to process multiple types of speech content. Especially for speech content of multiple time lengths, the recognition accuracy of the existing speech recognition model is low, and the recognition effect is poor.

Embodiments of the present disclosure provide a solution for training a speech recognition model. According to the solution, a speech sample set may be obtained. The speech sample set includes a first set of speech samples and a second set of language samples. A time length of the first set of speech samples is less than a first threshold, and a time length of the second set of speech samples is greater than a second threshold. And the speech recognition model is trained with the speech sample set and corresponding text information, to at least adjust parameters of a speech encoding unit in the speech recognition model. The speech recognition model includes the speech encoding unit and a decoding unit. The speech encoding unit is configured to generate a speech encoded representation of speech content, and the decoding unit is configured to generate a speech recognition result based on the speech encoded representation.

In this way, the embodiments of the present disclosure can train the speech recognition model based on the two sets of speech samples associated with different thresholds, so that the speech recognition model obtained by training can adapt to recognition of speech content of different time lengths, thereby improving efficiency and accuracy rate of speech recognition.

In addition, compared with simply dividing the long speech content into a plurality of short speech segments for recognition, embodiments of the present disclosure can realize recognition of long speech content with richer context information, thereby improving speech recognition accuracy.

Various example implementations of the scheme are described in detail below in conjunction with the accompanying drawings.

### Example Environment

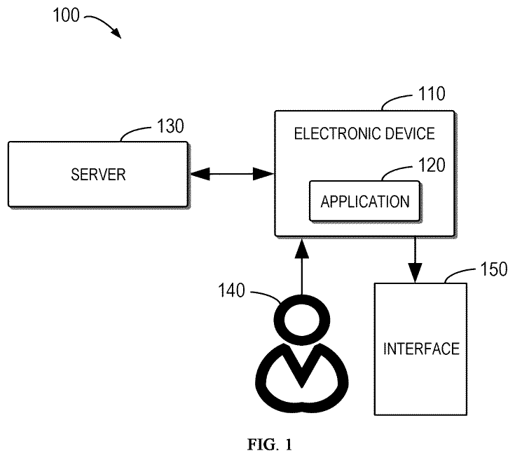

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to, speech applications or other applications related to speech recognition. The user 140 may interact with the application 120 via the electronic device 110 and/or its attachment device.

In the environment 100 of FIG. 1, if the application 120 is active, the electronic device 110 may present, through the application 120, an interface 150 for supporting interface interaction.

In some embodiments, the electronic device 110 communicates with the server 130 to enable provisioning of services to the application 120. The electronic device 110 may be any type of mobile terminals, fixed terminals, or portable terminals, including a mobile phone, a desktop computer, a laptop computer, a notebook computer, a netbook computer, a tablet computer, a media computer, a multimedia tablet, a palmtop computer, a portable game terminal, a VR/AR device, a Personal Communication System (PCS) device, a personal navigation device, a Personal Digital Assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be an independent physical server, may also be a server cluster or a distributed system formed by a plurality of physical servers, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for applications 120 that support a virtual scene presentation in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus connections (USB), Wireless Fidelity (WiFi) connections, etc., embodiments of the present disclosure are not limited in this respect. In an embodiment of the present disclosure, the server 130 and the electronic device 110 may implement signaling interaction through a communication connection between the server 130 and the electronic device 110.

It should be understood that the structures and functions of the various elements in environment 100 are described for illustrative purposes only and do not imply any limitation to the scope of the present disclosure.

Some example embodiments of the present disclosure will be described below with continued reference to the accompanying drawings.

### Example Processes

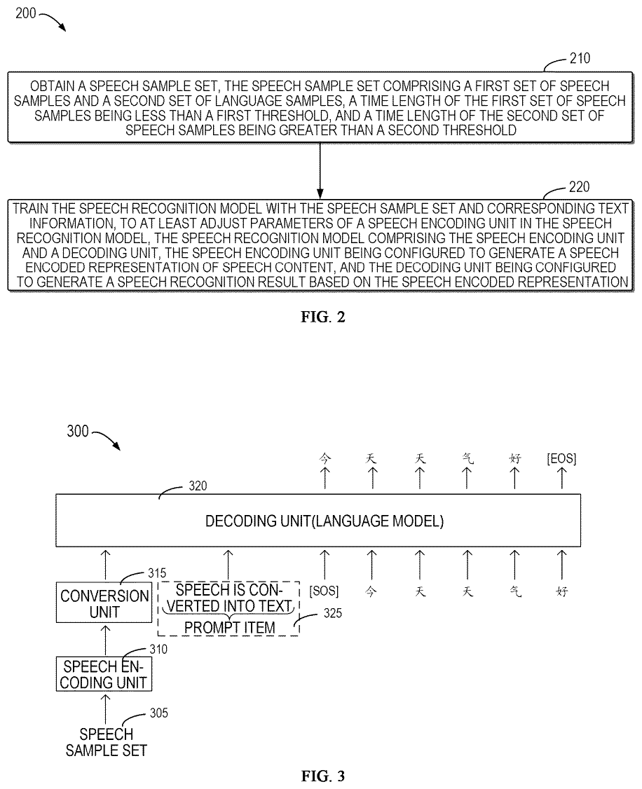

FIG. 2 illustrates a flowchart of an example process 200 of training a speech recognition model according to some embodiments of the present disclosure. The process 200 may be implemented at electronic device 110. The process 200 is described below with reference to FIG. 1.

As shown in FIG. 2, at block 210, the electronic device 110 may obtain a speech sample set. The speech sample set may include a first set of speech samples and a second set of language samples. A time length of the first set of speech samples may be less than a first threshold, and a time length of the second set of speech samples may be greater than a second threshold.

In some embodiments, the first threshold may be, for example, the same as the second threshold, or the first threshold may also be less than the second threshold. The present disclosure is not intended to limit the specific magnitudes of the first threshold and the second threshold. In some scenarios, the speech sample whose time length is less than the first threshold may also be referred to as a short speech sample, and the speech sample whose time length is greater than the second threshold may also be referred to as a long speech sample.

An example process of training a speech recognition model according to an embodiment of the present disclosure will be described below with reference to the speech recognition model 300 shown in FIG. 3.

FIG. 3 illustrates an example structure of a speech recognition model 300 according to some embodiments of the present disclosure. As shown in FIG. 3, the speech recognition model 300 may include a speech encoding unit 310, a conversion unit 315, and a decoding unit 320.

In some embodiments, referring to FIG. 3, the speech encoding unit 310 may generate, based on the speech content, a speech encoded representation (or referred to as a speech feature sequence) corresponding to the speech content. For example, the speech encoding unit 310 may generate, based on a speech sample set 305, a speech encoded representation corresponding to the speech sample set 305. As an example, the speech encoding unit 310 may be implemented as an audio encoder, for example.

In some embodiments, with continued reference to FIG. 3, the conversion unit 315 may convert the speech encoded representation into speech features for provision to the decoding unit 320. As an example, the conversion unit 315 may be implemented based on a mode converter, for example.

In some embodiments, with continued reference to FIG. 3, the decoding unit 320 may generate the speech recognition result based on the speech feature generated by the conversion unit 320. As an example, the decoding unit 320 may be, for example, a language model. By using the language model as the decoding unit 320, embodiments of the present disclosure may utilize the long text modeling capability of the language model to better process relevant context information of the long speech content to improve the accuracy of speech recognition.

In some other scenarios, the decoding unit 320 may further generate the speech recognition result directly based on the speech encoded representation outputted by the speech encoding unit 320. Accordingly, the conversion unit 315 may be omitted from the speech recognition model 300, for example.

In some embodiments, as shown in FIG. 3, the language model is used as an example of the decoding unit 320. The decoding unit 320 generates the speech recognition result based on a next token prediction (NTP), for example.

As shown in FIG. 3, <SOS> represents the start of sentence; <EOS> represents the end of sentence. As an example, the decoding unit 320 may predict a next token to be outputted based on a token sequence inputted. As an example, the outputted token may correspond to one character or one word.

Taking FIG. 3 as an example, after determining that the token outputted first is a “ [symbol] ”, the interface unit 320 may determine the next token to be outputted is a “ [symbol] ” based on the updated token sequence including the “ [symbol] ”, thereby implementing NTP-based speech recognition.

In some embodiments, as shown in FIG. 3, the token sequence inputted to the decoding unit 320 may further include a prompt item 325. The prompt item 325 may be configured to instruct the decoding unit 320 to perform a speech recognition task.

In some embodiments, the electronic device 110 may first pre-train the speech encoding unit 310 in the speech recognition model 300 with training speech data. For example, the electronic device 110 may pre-train the speech encoding unit 310 in the speech recognition model 300 through a Self-supervised Learning (SSL) process.

In some embodiments, during the pre-training process, the electronic device 110 may generate a first feature sequence (for example, a spectral feature) of the training speech sample. Further, the electronic device 110 may generate a second feature sequence by masking at least part of the first sequence feature. As an example, the electronic device 110 may randomly mask features corresponding to at least part of moments of the first sequence feature to obtain the second feature sequence.

In some embodiments, the electronic device 110 may process the second feature sequence with the speech encoding unit 310 to be trained, to generate the first label information. As an example, when the electronic device 110 may process the second feature sequence with the speech encoding unit 310, the feature may be encoded and the feature of the masked position may be predicted to obtain the first label information.

In some embodiments, the electronic device 110 may obtain a second label information by comparing the first feature sequence with the preset codebook. As an example, the preset codebook may include a set of preset feature representations. As an example, the electronic device 110 may obtain, based on a preset codebook, a set of indexes matching the first feature sequence as the second label information.

In some embodiments, the electronic device 110 may obtain a comparison result based on comparing the first label information and the second label information. Further, the electronic device 110 may adjust parameters of the speech encoding unit 310 based on the comparison result. In this way, the trained speech encoding unit 310 may have stronger prediction capability for non-consecutive (e.g., partial content is missing) speech content.

In some embodiments, to support the speech recognition model 300 to process speech samples of multiple time lengths, especially a speech sample of a relatively long time length, the electronic device 110 may train the speech recognition model with mixture of speech samples of different time lengths.

In some embodiments, the electronic device 110 may construct the set of speech samples 305 with the first set of speech samples and the second set of speech samples with different time lengths. In some scenarios, for example, the first set of speech samples may also be referred to as “short speech samples”, and for example, the second set of speech samples may also be referred to as “long speech samples”. It should be understood that thresholds for distinguishing “short speech samples” and “long speech samples” may be properly set based on actual situations, which is not limited in the embodiments of the present disclosure.

In some embodiments, the second set of samples may include a plurality of speech samples corresponding to a plurality of preset time lengths. As an example, the second set of samples may be obtained by average sampling based on a preset time range greater than a second threshold. As an example, the second threshold may be, for example, 0.2 h, and the preset time range may be 0.2 h to 3 h. Further, for example, the preset step length may be determined as 0.2 h, and the plurality of preset time lengths may include 0.2 h, 0.4 h, . . . , 2.8 h, and 3 h. Further, the second set of samples may include a preset number of samples corresponding to each preset time length. For example, each preset time length may sample about 100 samples. It should be noted that this is only an illustrative description, and the specific values of the second threshold, the preset time range, the preset step length, and the plurality of preset time lengths are not limited herein.

In some embodiments, the electronic device 110 may further obtain text information associated with the speech sample set 305. As an example, the text information may be used as annotation information corresponding to the speech sample set 305.

At block 220, the electronic device 110 may train the speech recognition model with the speech sample set 305 and the corresponding text information to at least adjust parameters of the speech encoding unit 310 in the speech recognition model.

In some embodiments, the electronic device 110 may determine a target loss for the speech recognition model at least based on the text information corresponding to the speech sample set 305 and a speech recognition result. Further, the electronic device 110 may adjust parameters involved in the speech recognition model based on the target loss.

In some embodiments, the speech recognition result may include a prediction result obtained by the decoding unit 320 predicting based on the next token. The electronic device 110 may further determine a target loss based on the prediction result and the text information.

In some embodiments, in the process of training the speech recognition model, the electronic device 110 may further adjust parameters of the conversion unit 315 based on the speech sample set 305 and the text information corresponding to the speech sample set 305. As an example, the electronic device 110 may adjust the parameters of the conversion unit 315 based on comparing the text information corresponding to the speech sample set 305 with the speech recognition result produced by the speech recognition model. In some embodiments, such loss includes a loss of language model executing token prediction when decoding unit 320 includes a language model.

In some embodiments, the electronic device 110 may further fix parameters of the decoding unit 320 when training the speech recognition model based on the speech sample set 305 and the corresponding text information. It may be understood that the parameters of the decoding unit 320 are fixed, which may avoid affecting the decoding unit 320 in the process of training the speech recognition model.

In some embodiments, the electronic device 110 may further fine-tune the parameters of the decoding unit 320 when training the speech recognition model based on the speech sample set 305 and the corresponding text information. As an example, when training the speech recognition model, the electronic device 110 may set a relatively small learning rate for the decoding unit 320, so as to fine tune the decoding unit 320.

In some embodiments, the electronic device 110 may further adjust parameters of the fine-tuning unit associated with the decoding unit 320 when training the speech recognition model based on the speech sample set 305 and the corresponding text information. As an example, the electronic device 110 may accordingly adjust parameters of a Low-Rank Adaption (LoRA) unit associated with the decoding unit 320.

In some embodiments, the electronic device 110 may train the speech recognition model through a plurality of training stages with the speech sample set 305 and the corresponding text information. Specifically, the above process of training the speech recognition model with the mixed samples may correspond to a second training stage.

In some embodiments, the electronic device 110 may train the speech recognition model with the first set of speech training samples in the first training stage. In this way, through the training in the first training stage, a speech recognition model with strong processing capability for speech content whose time length is less than the first threshold may be obtained.

In some embodiments, the electronic device 110 may train the speech recognition model with a mixture of the first set of speech samples and the second set of speech samples at a second training stage, as described above with reference to FIG. 2. As an example, the mixture of the first set of speech samples and the second set of speech samples may enable the speech recognition model to process speech content of multiple time lengths. In this way, the speech recognition model may have processing capability for speech content of multiple time lengths simultaneously.

In some embodiments, the electronic device 110 may determine a recognition performance of the speech recognition model based on the speech sample set 305 used for training the speech recognition model and/or a test on the recognition capability of the speech recognition model. As an example, it may be determined that the speech recognition model achieves a better recognition efficiency and/or a better recognition accuracy on a target time length of the speech content.

In some embodiments, the electronic device 110 may obtain the target speech content to be processed. Further, the electronic device 110 may divide the target speech content into a plurality of speech segments based on the target time length in response to the length (for example, the time length) of the target speech content being greater than a third threshold. Further, the electronic device 110 may process the plurality of speech segments with the trained speech recognition model to generate a speech generation result for the target speech content.

As an example, the electronic device 110 may process the plurality of speech segments with the trained speech recognition model to obtain a plurality of speech recognition results. Further, the electronic device 110 may concatenate the plurality of speech recognition results in a corresponding order of the plurality of speech segments to obtain a speech generation result of the target speech content. The specific value of the third threshold is not limited in the present disclosure. In this way, for speech content with a relatively long time length (for example, several hours to tens of hours), the speech content is divided based on the recognition performance of the speech recognition model, so that the efficiency and accuracy of processing the speech content by the model can be improved.

Based on the training process described above, the embodiments of the present disclosure can adjust parameters of various units (or modules) in the speech recognition model based on speech samples of different time lengths, to obtain a trained speech recognition model. When the speech content is processed based on the speech recognition model, the speech content may be divided into a plurality of speech segments based on the performance of the speech recognition model for processing.

Further, in the speech recognition stage, the embodiments of the present disclosure can adaptively divide the speech content with a too long time length, thereby improving the training efficiency of the speech recognition model and the ability to recognize the speech content.

### Example Apparatus and Device

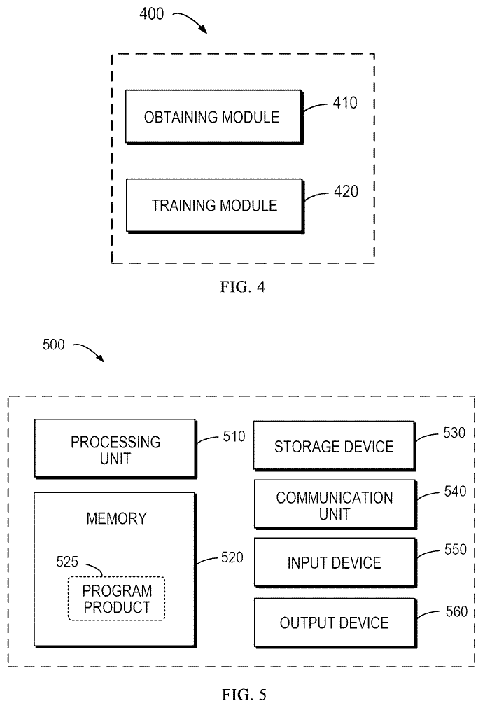

The embodiments of the present disclosure also provide a corresponding apparatus for implementing the above method or process. FIG. 4 illustrates a schematic structural block diagram of an example apparatus 400 for training a speech recognition model according to some embodiments of the present disclosure. The apparatus 400 may be implemented as the electronic device 110 or included in the electronic device 110. The various modules/components in the apparatus 400 may be implemented by hardware, software, firmware, or any combination thereof.

As shown in FIG. 4, the apparatus 400 includes an obtaining module 410, configured to obtain a speech sample set, the speech sample set including a first set of speech samples and a second set of language samples, a time length of the first set of speech samples being less than a first threshold, and a time length of the second set of speech samples being greater than a second threshold; and a training module 420, configured to train the speech recognition model with the speech sample set and corresponding text information, to at least adjust parameters of a speech encoding unit in the speech recognition model, the speech recognition model including the speech encoding unit and a decoding unit, the speech encoding unit being configured to generate a speech encoded representation of speech content, and the decoding unit being configured to generate a speech recognition result based on the speech encoded representation.

In some embodiments, the second set of speech samples includes a plurality of speech samples corresponding to a plurality of preset time lengths.

In some embodiments, the training module 420 is further configured to: adjust, based on the speech sample set and the text information, parameters of a pre-trained speech encoding unit in the speech recognition model, where the speech encoding unit is pre-trained based on training speech data.

In some embodiments, the training module 420 is further configured to: generate a first feature sequence for training a speech sample; generate a second feature sequence by masking at least part of the first feature sequence; process the second feature sequence with the speech encoding unit to generate first label information; and adjust, based on a comparison between the first label information and the second label information, the parameters of the speech encoding unit, the second label information being generated based on a comparison between the first feature sequence and a preset codebook.

In some embodiments, the speech recognition model further comprises a conversion unit configured to convert the speech encoded representation into speech features processed by the decoding unit.

In some embodiments, the training module 420 is further configured to: adjust parameters of the conversion unit based on the speech sample set and the text information.

In some embodiments, the training module 420 is further configured to: fix parameters of the decoding unit; fine-tune parameters of the decoding unit; or adjust parameters of a fine-tuning unit associated with the decoding unit.

In some embodiments, the training module 420 is further configured to: train, in a first training stage, the speech recognition model with the first set of speech samples; and train, in a second training stage, the speech recognition model with a mixture of the first set of speech samples and the second set of speech samples.

In some embodiments, the apparatus 400 further includes a processing module configured to: obtain target speech content to be processed; divide, in response to a length of the target speech content being greater than a third threshold, and based on a target time length, the target speech content into a plurality of speech segments; and process the plurality of speech segments with the trained speech recognition model to generate a speech generation result for the target speech content.

In some embodiments, the target time length is determined based on a recognition performance of the speech recognition model for speech content of different time lengths.

FIG. 5 illustrates a block diagram of an electronic device 500 capable of implementing one or more embodiments of the present disclosure. It should be understood that the electronic device 500 shown in FIG. 5 is merely for example and should not constitute any limitation on the function and scope of the embodiments described herein. The electronic device 500 shown in FIG. 5 may be configured to implement the electronic device 110 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

The electronic device 500 typically includes a plurality of computer storage media. Such media may be any available media accessible by the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method, comprising:
obtaining a speech sample set, the speech sample set comprising a first set of speech samples and a second set of language samples, a time length of the first set of speech samples being less than a first threshold, and a time length of the second set of speech samples being greater than a second threshold; and
training a speech recognition model with the speech sample set and corresponding text information, to at least adjust parameters of a speech encoding unit in the speech recognition model, the speech recognition model comprising the speech encoding unit and a decoding unit, the speech encoding unit being configured to generate a speech encoded representation of speech content, and the decoding unit being configured to generate a speech recognition result based on the speech encoded representation.

2. The method of claim 1, wherein the second set of speech samples comprises a plurality of speech samples corresponding to a plurality of preset time lengths.

3. The method of claim 1, wherein training the speech recognition model with the speech sample set and the corresponding text information comprises:
adjusting, based on the speech sample set and the corresponding text information, parameters of a pre-trained speech encoding unit in the speech recognition model, wherein the pre-trained speech encoding unit is pre-trained based on training speech data.

4. The method of claim 3, wherein the pre-trained speech encoding unit is pre-trained based on a self-supervised training process, the self-supervised training process comprising:
generating a first feature sequence for training a speech sample;
generating a second feature sequence by masking at least part of the first feature sequence;
processing the second feature sequence with the pre-trained speech encoding unit to generate first label information; and
adjusting, based on a comparison between the first label information and second label information, the parameters of the pre-trained speech encoding unit, the second label information being generated based on a comparison between the first feature sequence and a preset codebook.

5. The method of claim 1, wherein the speech recognition model further comprises a conversion unit configured to convert the speech encoded representation into speech features processed by the decoding unit.

6. The method of claim 5, wherein training the speech recognition model with the speech sample set and the corresponding text information further comprises:
adjusting parameters of the conversion unit based on the speech sample set and the corresponding text information.

7. The method of claim 1, wherein training the speech recognition model with the speech sample set and the corresponding text information further comprises:
fixing parameters of the decoding unit;
fine-tuning parameters of the decoding unit; or
adjusting parameters of a fine-tuning unit associated with the decoding unit.

8. The method of claim 1, wherein training the speech recognition model with the speech sample set and the corresponding text information further comprises:
training, in a first training stage, the speech recognition model with the first set of speech samples; and
training, in a second training stage, the speech recognition model with a mixture of the first set of speech samples and the second set of speech samples.

9. The method of claim 1, further comprising:
obtaining target speech content to be processed;
dividing, in response to a length of the target speech content being greater than a third threshold, and based on a target time length, the target speech content into a plurality of speech segments; and
processing the plurality of speech segments with the speech recognition model to generate a speech generation result for the target speech content.

10. The method of claim 9, wherein the target time length is determined based on a recognition performance of the speech recognition model for speech content of different time lengths.

11. An electronic device, comprising:
at least one processor; and
at least one memory coupled to the at least one processor and storing instructions for execution by the at least one processor, the instructions, when executed by the at least one processor, causing the electronic device to perform operations comprising:
obtaining a speech sample set, the speech sample set comprising a first set of speech samples and a second set of language samples, a time length of the first set of speech samples being less than a first threshold, and a time length of the second set of speech samples being greater than a second threshold; and
training a speech recognition model with the speech sample set and corresponding text information, to at least adjust parameters of a speech encoding unit in the speech recognition model, the speech recognition model comprising the speech encoding unit and a decoding unit, the speech encoding unit being configured to generate a speech encoded representation of speech content, and the decoding unit being configured to generate a speech recognition result based on the speech encoded representation.

12. The electronic device of claim 11, wherein the second set of speech samples comprises a plurality of speech samples corresponding to a plurality of preset time lengths.

13. The electronic device of claim 11, wherein training the speech recognition model with the speech sample set and the corresponding text information comprises:
adjusting, based on the speech sample set and the corresponding text information, parameters of a pre-trained speech encoding unit in the speech recognition model, wherein the pre-trained speech encoding unit is pre-trained based on training speech data.

14. The electronic device of claim 13, wherein the pre-trained speech encoding unit is pre-trained based on a self-supervised training process, the self-supervised training process comprising:
generating a first feature sequence for training a speech sample;
generating a second feature sequence by masking at least part of the first feature sequence;
processing the second feature sequence with the pre-trained speech encoding unit to generate first label information; and
adjusting, based on a comparison between the first label information and second label information, the parameters of the pre-trained speech encoding unit, the second label information being generated based on a comparison between the first feature sequence and a preset codebook.

15. The electronic device of claim 11, wherein the speech recognition model further comprises a conversion unit configured to convert the speech encoded representation into speech features processed by the decoding unit.

16. The electronic device of claim 15, wherein training the speech recognition model with the speech sample set and the corresponding text information further comprises:
adjusting parameters of the conversion unit based on the speech sample set and the corresponding text information.

17. The electronic device of claim 11, wherein training the speech recognition model with the speech sample set and the corresponding text information further comprises:
fixing parameters of the decoding unit;
fine-tuning parameters of the decoding unit; or
adjusting parameters of a fine-tuning unit associated with the decoding unit.

18. The electronic device of claim 11, wherein training the speech recognition model with the speech sample set and the corresponding text information further comprises:
training, in a first training stage, the speech recognition model with the first set of speech samples; and
training, in a second training stage, the speech recognition model with a mixture of the first set of speech samples and the second set of speech samples.

19. The electronic device of claim 11, wherein the operations further comprise:
obtaining target speech content to be processed;
dividing, in response to a length of the target speech content being greater than a third threshold, and based on a target time length, the target speech content into a plurality of speech segments; and
processing the plurality of speech segments with the speech recognition model to generate a speech generation result for the target speech content.

20. A non-transitory computer-readable storage medium storing a computer program thereon, the computer program being executable by a processor to perform operations comprising:
obtaining a speech sample set, the speech sample set comprising a first set of speech samples and a second set of language samples, a time length of the first set of speech samples being less than a first threshold, and a time length of the second set of speech samples being greater than a second threshold; and
training a speech recognition model with the speech sample set and corresponding text information, to at least adjust parameters of a speech encoding unit in the speech recognition model, the speech recognition model comprising the speech encoding unit and a decoding unit, the speech encoding unit being configured to generate a speech encoded representation of speech content, and the decoding unit being configured to generate a speech recognition result based on the speech encoded representation.
